(19) United States
(12) Patent Application Publication
(10) Pub. No.: US 2007/0103911 A1
(43) Pub. Date: May 10, 2007

(54) Lighting device

(76) Inventor: Gabrielle Johanna Bernarda Maria Meekes, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/579,153

(22) PCT Filed: Nov. 2, 2004
(86) PCT No.: PCT/IB04/52267

§ 371 Date: May 12, 2006

(30) Foreign Application Priority Data
Nov. 17, 2003 (EP) 03104218.7

(51) Int. Cl. F21V 7/00

(52) U.S. Cl. 362/341

(57) ABSTRACT

A lighting device (1) comprising at least one light source (4) arranged in a housing (2) for emitting a lighting beam through a light-transmitting plate (3) of the housing (2), wherein said plate (3) is provided with means which reflect incident light on the plate (3), in such a manner that light which locally has a higher intensity is reflected more strongly at that location than light which locally has a lower intensity, with the special feature that said light-transmitting plate (3) and said means together form a constructional element made in one piece of a diffuse reflective material.

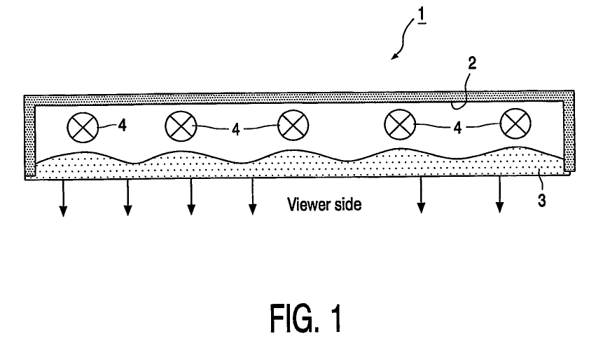

The invention relates to a lighting device comprising at least one light source arranged in a housing for emitting a lighting beam through a light-transmitting plate of the housing, wherein said plate is provided with means which reflect incident light on the plate, in such a manner that light which locally has a higher intensity is reflected more strongly at that location than light which locally has a lower intensity.

Such a lighting device is generally known. The known lighting device is usually a flat light box, such as the light box that is used for the visual inspection of x-ray photographs, for realising flat lighting tiles or lighting walls attached to walls or ceilings for general lighting purposes, or for backlighting advertising columns, billboards, or LCD screens. As a rule, the at least one light source that is present in the light box is at least partly surrounded by a reflector for reflecting the light emitted by the light source in a direction away from the light-transmitting plate back to the light-transmitting plate. An important practical requirement concerning such products is that the light exiting from the light-transmitting plate must exhibit a substantially homogeneous intensity over substantially the entire plate area, so that the location and the shape of the light source—for example in the form of one or more TL tubes in the case of a light box—cannot be distinguished as such from the outside. In order to accomplish this, it is known to apply a coating having a locally varying thickness, usually consisting of light-diffusing inorganic particles dispersed in an organic binder matrix, to the entire light-transmitting plate, for instance by spraying. The locally varying thickness causes the optical reflection of incident light on the plate to vary locally, wherein a coating which is locally relatively thicker effects a higher degree of reflection at the location in question than a coating which is locally relatively thinner. Consequently, the local variation in thickness in the coating must be selected so that the coating reflects incident light on the plate in such a manner that light which locally has a higher intensity is reflected more strongly by the coating at the location in question than light which locally has a lower intensity.

One drawback of the known lighting device is the fact that, in particular in the case of very flat light boxes, the required lateral thickness profile of the coating on the plate must exhibit a lateral thickness gradient which is so large and which, moreover, has been adjusted so precisely in order to effect the desired reflection/transmission gradient over the entire light-transmitting plate, that, in practice, it is not possible to apply such a coating sufficiently reliably and efficiently.

The object of the invention is to overcome this drawback of the prior art, and in order to accomplish that objective a lighting device of the kind according to the invention as referred to in the introduction is characterized in that said light-transmitting plate and said means together form a constructional element made in one piece of a diffuse reflective material. In other words, said light-transmitting plate is a diffuse reflective plate of its own, hereinafter also referred to as a diffusor, by manufacturing the plate of a diffuse reflective material. The visual effect that is achieved therewith is that the light emitted by the lighting device has a laterally homogeneous intensity.

In one preferred embodiment of a lighting device in accordance with the invention said element is made of a plastic material comprising diff-use reflective particles. Particularly, said diffuse reflective particles comprise calcium halophosphate, calcium pyrophosphate, MgO, YBO₃, TiO₂ or Al₂O₃ particles. In the alternative, said element of a plastic material comprises air bubbles enclosed in the plastic material in order to create a diffuse reflective material. Diffuse reflection can also be realized by a cristalline structure of said plastic material. Said plastic material is preferably chosen from the group consisting of acrylic plastics, fluoroplastics, polysiloxanes, polyesters, polycarbonates.

In another preferred embodiment of a lighting device according to the invention said element comprises a profile with a varying thickness in such a manner that the thickness of the element at a location close to the light source is larger than at a location further removed from the light source. Said profile may be located on a side of the diffusor facing away or facing towards the light source. More in particular, the transmission of light by the diffusor at a location opposite the light source amounts to 80% of the transmission of light by the diffusor at a location being at a maximum distance from the light source.

In another preferred embodiment of a lighting device in accordance with the invention said profile is made through grinding or embossing. In the alternative, said profile is made through moulding or extrusion.

The invention also refers to a method for laterally homogenising of the intensity of light emitted from a lighting device comprising at least one light source arranged in a housing for emitting a lighting beam through a light-transmitting plate of the housing, wherein said plate is provided with means which reflect incident light on the plate, in such a manner that light which locally has a higher intensity is reflected more strongly at that location than light which locally has a lower intensity, characterized in that said light-transmitting plate and said means together are formed as a constructional element made in one piece of a diffuse reflective material.

The invention will now be explained in more detail with reference to a figure illustrated in a drawing, which drawing is a schematic, cross-sectional view of a lighting device according to the invention.

The FIGURE shows a lighting device in the form of a light box 1 including a reflective material 2 on its innerside and a glass or plastic plate 3 mounted thereon. In order to ensure that TL-tubes 4 in the housing 2 cannot be distinguished from the outside, incident light on the plate 3 coming from the TL-tubes 4 must be made to exit the plate 3 with a homogeneous intensity over the entire area of the plate 3. To this end, the plate 3 is build as a diffusor of its own, that is it transmits light from the TL-tubes in a diffuse reflective manner by making the plate 3 as such of a diffuse reflective material, for example PMMA (PolyMethylMetAcrylate) having Al₂O₃ particles dispersed therein.

By making the plate 3 locally thicker at a location opposite the TL-tubes 4 than elswhere, light which locally has a higher intensity will be reflected more strongly at that location (i.e. at a location opposite the TL-tubes 4) than light which locally has a lower intensity (i.e. at a location between neighbouring TL-tubes 4, for example).

The invention is not retsricted to the embodiment shown, but extends also to other embodiments falling within the scope of the appended claims.

1. A lighting device comprising at least one light source arranged in a housing for emitting a lighting beam through a light-transmitting plate of the housing, wherein said plate is provided with means which reflect incident light on the plate, in such a manner that light which locally has a higher intensity is reflected more strongly at that location than light which locally has a lower intensity, characterized in that said light-transmitting plate and said means together form a constructional element made in one piece of a diffuse reflective material.

2. A lighting device according to claim 1, wherein said element is made of a plastic material comprising diffuse reflective particles.

3. A lighting device according to claim 2, wherein said diffuse reflective particles comprise calcium halophosphate, calcium pyrophosphate, MgO, YBO₃, TiO₂ or Al₂O₃ particles.

4. A lighting device according to claim 2, wherein said plastic material is chosen from the group consisting of acrylic plastics, fluoroplastics, polysiloxanes, polyesters, polycarbonates.

5. A lighting device according to claim 1, wherein said element comprises a profile with a varying thickness in such a manner that the thickness of the element at a location close to the light source is larger than at a location further removed from the light source.

6. A lighting device according to claim 5, wherein said profile is made through grinding or embossing.

7. A lighting device according to claim 5, wherein said profile is made through moulding or extrusion.

8. A method for laterally homogenising of the intensity of light emitted from a lighting device comprising at least one light source arranged in a housing for emitting a lighting beam through a light-transmitting plate of the housing, wherein said plate is provided with means which reflect incident light on the plate, in such a manner that light which locally has a higher intensity is reflected more strongly at that location than light which locally has a lower intensity, characterized in that said light-transmitting plate and said means together are formed as a constructional element made in one piece of a diffuse reflective material.
